(19) United States
(12) Patent Application Publication
(10) Pub. No.: US 2008/0100113 A1
(43) Pub. Date: May 1, 2008

(54) Power seat motor mounting assembly

(75) Inventors: Scott T. Kropfreiter, Warren, MI (US); Vien Le, Sterling Heights, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/580,434

(22) Filed: Oct. 13, 2006

(51) Int. Cl. A47C 1/023; F16M 13/00

(52) U.S. Cl. 297/344.17; 297/344.11; 248/424

(57) ABSTRACT

A mounting rail assembly for a drive motor coupled to operate a vehicle mechanism includes a vehicle frame member. A mounting rail is secured to the vehicle frame member and has a plurality of spaced apart first attachment features. A drive motor has a second attachment feature and is selectively attachable to any of the first attachment features of the mounting rail to provide a desired motor mounting location relative to the vehicle frame member.

### BACKGROUND

Various embodiments of a mounting rail assembly are described herein. In particular, the embodiments described herein relate to an improved mounting rail assembly for a drive motor coupled to operate a vehicle mechanism.

Power seat adjusters are a popular option on many automotive vehicles and are frequently offered as standard equipment on higher priced vehicles. Such power seat adjusters are primarily used on the driver's seat and, sometimes, on the front passenger seat of the vehicle to provide selective horizontal fore and aft and vertical movement of the seat, as well as seat back recliner movement to accommodate occupants of different size and height, and to provide a comfortable seating position to suit each occupant's preference.

Such power seat adjusters typically carry a seat support frame which supports the seat bottom and sometimes the seat back of a vehicle seat. The seat support frame is mounted on first and second, spaced track assemblies, each formed of an upper track which is connected to the seat support frame and which is slidably mounted on a lower track anchored to the vehicle floor.

The power seat adjuster may include a plastic frame for mounting seat adjusting motors which provide, for example, horizontal (fore/aft), front vertical, and rear vertical movement of the seat. Unique plastic frames are typically required for each vehicle platform, thereby requiring unique and costly tooling for each vehicle platform. It would therefore be advantageous to provide an improved motor mounting assembly for a power seat adjuster.

### SUMMARY

The present application describes various embodiments of a mounting rail assembly for a drive motor coupled to operate a vehicle mechanism. One embodiment of the mounting rail assembly includes a vehicle frame member. A mounting rail is secured to the vehicle frame member and has a plurality of spaced apart first attachment features. A drive motor has a second attachment feature and is selectively attachable to any of the first attachment features of the mounting rail to provide a desired motor mounting location relative to the vehicle frame member.

Other advantages of the mounting rail assembly will become apparent to those skilled in the art from the following detailed description, when read in light of the accompanying drawings.

### BRIEF DESCRIPTION OF THE DRAWINGS

FIG. 1 is a top perspective view of a power seat drive assembly showing an embodiment of the mounting rail assembly.

FIG. 2 is an enlarged perspective view of the mounting rail assembly illustrated in FIG. 1.

FIG. 3 is an enlarged, exploded top perspective view of the mounting rail assembly illustrated in FIGS. 1 and 2.

FIG. 4 is an enlarged side elevation view of the mounting rail assembly illustrated in FIGS. 1, 2, and 3.

### DETAILED DESCRIPTION OF THE INVENTION

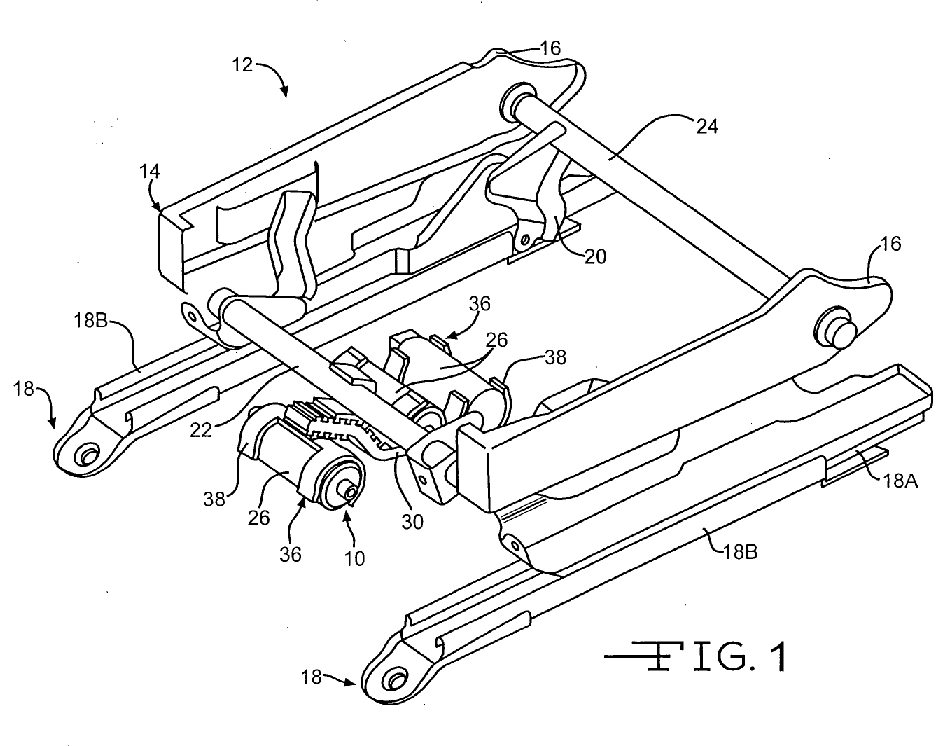

Referring now to the drawings, and to FIG. 1 in particular, a power seat drive motor mounting rail assembly is shown generally at 10. The illustrated mounting rail assembly 10 is shown mounted to a power seat drive assembly 12, which variably positions an automotive vehicle seat in one of a plurality of occupant selected positions. The illustrated power seat drive assembly 12 provides horizontal (fore and aft), vertical (up and down), and independent movement of each of the front and rear portions of the seat drive assembly 12. It will be understood however, that the mounting rail assembly 10 described hereafter is employable with a power seat drive assembly which provides any horizontal and vertical movement, alone or in combination with any of the other such movements described above.

The illustrated power seat drive assembly 12 supports a conventional vehicle seat (not shown), which includes a seat bottom or cushion, a seat back, and a vehicle frame member. In the illustrated embodiment, the vehicle frame member is an upper seat support frame or cushion pan 14 provided for supporting and connecting the seat bottom and the seat back to the power seat drive assembly 12. For illustrative purposes, only a portion of the cushion pan 14 is shown. The cushion pan 14 includes a pair of spaced, longitudinally extending rails or frame members 16. Mounting surfaces on the frame members 16 enable connection of a seat bottom (not shown) to the cushion pan 14. It will be understood that in lieu of the seat support frame members 16, suitable mounting brackets (not shown) may be provided on the power seat drive assembly 12 for direct attachment of a seat bottom of a vehicle seat to the power seat drive assembly 12.

The drive assembly 12 further includes a pair of track assemblies 18. Each track assembly 18 includes an inner track 18A slidably mounted relative to an outer track 18B. In the illustrated embodiment, the outer tracks 18B are affixed to the floor (not shown) of the vehicle. A pivot bracket 20 extends outwardly (upwardly as viewed in FIG. 1) from each inner tack 18A. In the illustrated embodiment, the pivot bracket 20 is pivotally attached to the inner track 18A and is further attached to the rear torsion rod 24 (described below).

The illustrated power seat drive assembly 12 also includes front and rear tubular torsion tubes or rods 22 and 24, respectively, to provide a rigid support structure for the power seat drive assembly 12. The front torsion rod 22 extends between and is connected to the pivot brackets 20. The rear torsion rod 24 extends between and is connected to the frame members 16. It will be understood that other numbers, combinations, and arrangements of torsion rods and power seat drive assembly components may be used. For example, the mounting rail assembly 10 described herein may be used with a power seat drive assembly that has three or more torsion rods.

Various drive assemblies may be mounted on the power seat drive assembly 12 to provide selective movement of the power seat adjuster along various axes. For example, drive motors 26 may be provided and coupled or connected to conventional lead screws, drive blocks or nuts, links (not shown) and the torsion bars x and/or y to independently elevate the front and rear edges of the seat support frame members 16, and thereby to provide selective, vertical adjustment of the front and rear portions of the vehicle seat. In the illustrated embodiment, three drive motors 26 are illustrated. It will be understood that the number of drive motors 26 will vary depending on the number of seat adjustment functions provided in the vehicle.

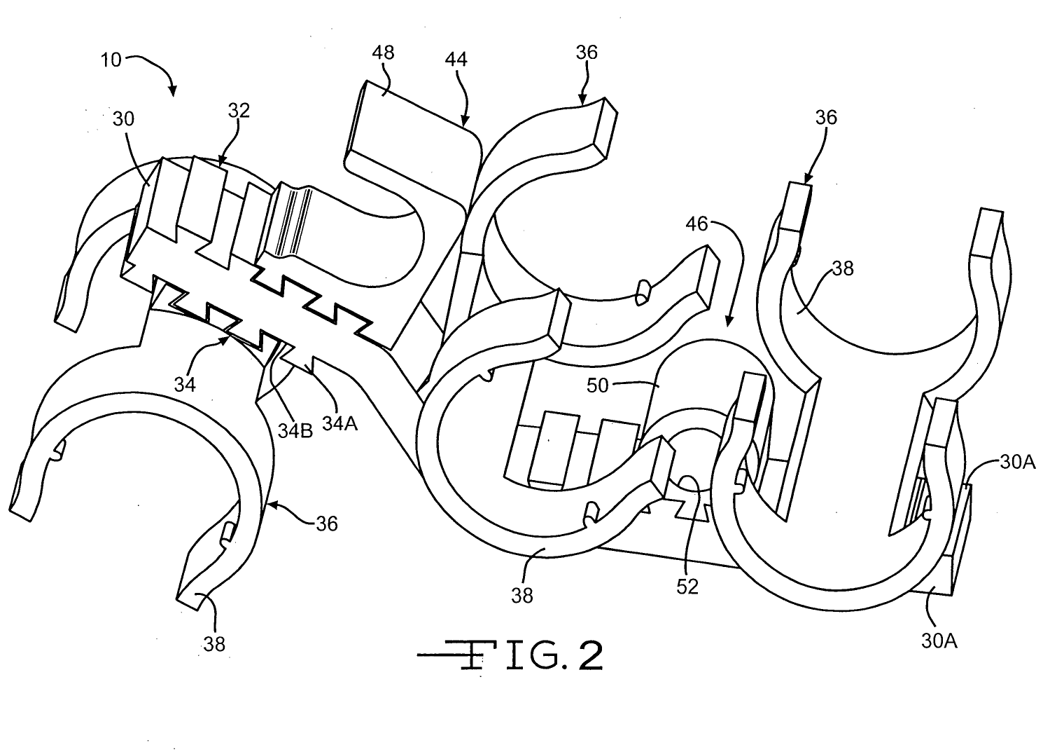

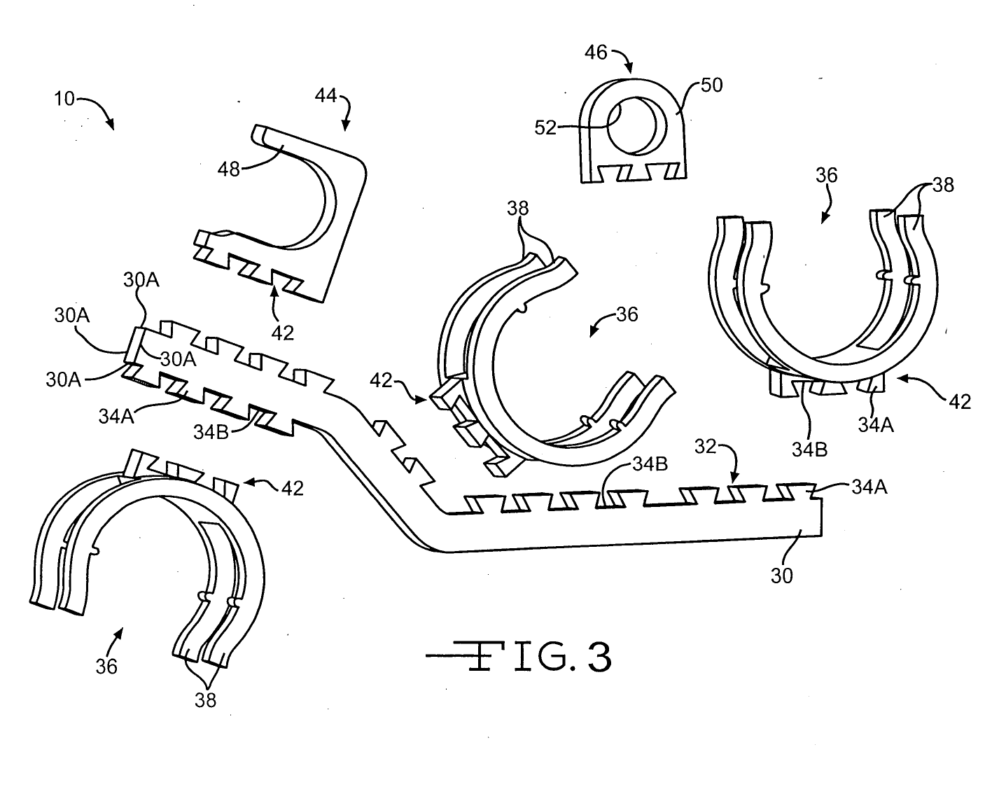

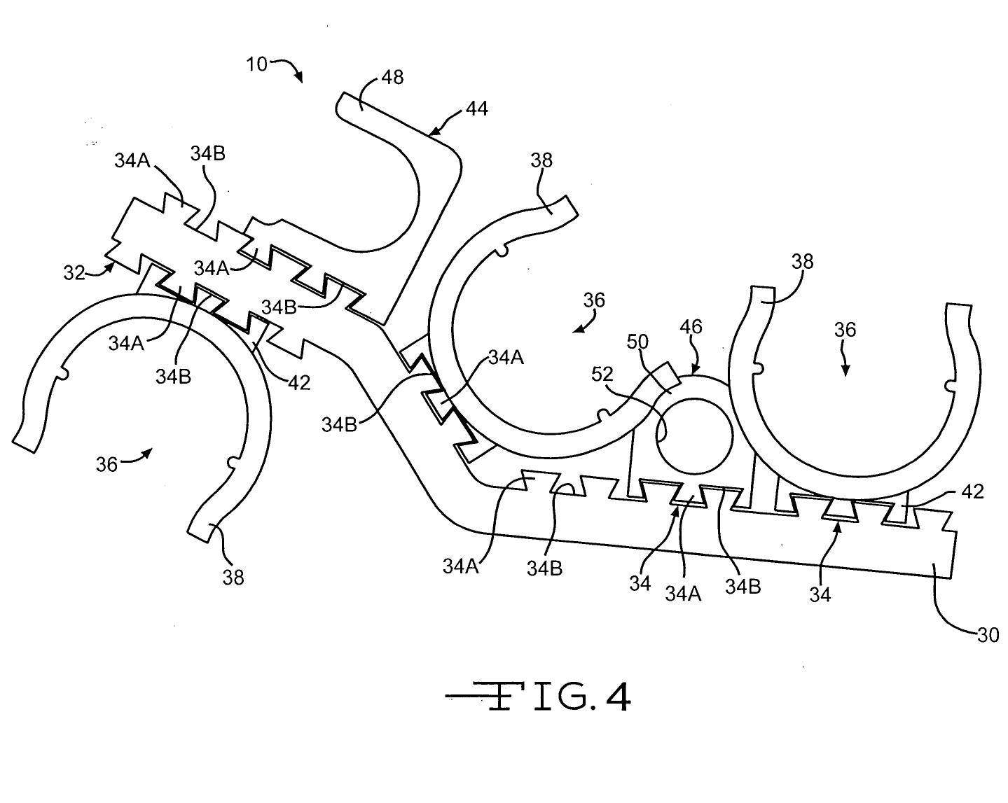

Referring to FIGS. 2 through 4, an embodiment of the mounting rail assembly for a power seat drive motor is shown generally at 10. The illustrated mounting rail assembly 10 includes an elongated mounting rail 30 having a predetermined external contour and four side surfaces 30A. In the illustrated embodiment, the rail 30 has a substantially rectangular transverse section. Alternatively, the rail 30 may have any other desired shape, such as for example, a transverse section having any other polygonal shape, or having an oval or round shape.

A plurality of spaced apart first attachment features 32 may be formed on at least one surface 30A of the mounting rail 30. In the illustrated embodiment, the first attachment features 32 are formed on two opposing surfaces 30A of the mounting rail 30. Alternatively, the first attachment features 32 may be formed on any desired number of surfaces of the mounting rail 30. The illustrated first attachment features 32 define the first half of a dovetail joint 34, and includes alternating pins 34A and dovetail portions 34B.

It may be desirable to provide a mounting rail 30 having only one predetermined external contour. Such a mounting rail 30 may be fabricated or otherwise formed from a suitable substantially rigid material such as for example, steel, aluminum, alloys thereof, plastic, resin, or other metals and non-metals.

Alternatively and advantageously, the mounting rail 30 may be formed from a substantially flexible material, such that the rail 30 may be selectively shaped to define a plurality of external contours, and therefore be mounted to any of a plurality of power seat drive assemblies or seat frames configurations. Suitable flexible materials include plastic and resin, such as for example, glass-filled nylon. Alternatively, other suitable materials, such as metal or other non-metals may be used.

In the embodiment illustrated in FIGS. 2 through 4, a first or drive motor attachment member 36 is provided for each of the drive motors 26. The motor attachment members 36 include a fastener or clip portion 38 for mounting a motor 26 (as best shown in FIG. 1) and a second attachment feature 42. The illustrated second attachment feature 42 defines the second half of the dovetail joint 34, and includes the alternating pins 34A and dovetail portions 34B. The second attachment feature 42 cooperates with any of the first attachment features 32 of the rail 30 such that the drive motor attachment member 36 may be selectively attached to any of the first attachment features 32 at any desired location on the mounting rail 30 to provide a desired motor mounting location relative to the cushion pan 14. Alternatively, the second attachment feature 42 may be integral with the drive motor 26, thereby eliminating the need for the motor attachment members 36.

As also illustrated in FIGS. 2 through 4, second and third attachment members 44 and 46 are provided. The second attachment member 44 includes the second attachment feature 42 and a fastener or clip portion 48 structured and configured for attaching to the power seat drive assembly 12. In the illustrated embodiment, the attachment member 44 is structured and configured for attachment to the front torsion rod 22. Alternatively, the attachment member 44 may be structured and configured for attachment to any other desired component of the power seat drive assembly 12.

The third attachment member 46 includes a body portion 50 having an aperture 52 structured and configured for receiving and/or mounting to a component of the power seat drive assembly 12. For example, in the illustrated embodiment, the attachment member 46 may be used to attach the mounting rail assembly 10 to an additional torsion rod (not shown). Alternatively, the attachment member 46 may receive a component of the power seat drive assembly 12, such as for example, a wiring harness (not shown). It will be understood that the third attachment member 46 may be structured and configured to receive any other vehicle component or component of the power seat drive assembly 12, or for attachment to any other desired vehicle component.

Advantageously, any of the drive motor attachment members 36, and the second and third attachment members 44 and 46 may be selectively attached to any of the first attachment features 32 at any desired location on the mounting rail 30 before the rail is mounted within a vehicle, or during servicing or maintenance of the mounting rail assembly 10.

In the illustrated embodiment, the first and second attachment features 32 and 42 of the mounting rail 30, motor attachment member 36, second attachment member 44, and third attachment member 46, are the pin 34A and dovetail portions 34B of a dovetail joint 34. Alternatively, the first and second attachment features 32 and 42 may be any desired attachment features, such as for example, a grid of holes for receiving bosses or fasteners. Such fasteners may be any desired fastener, such as for example, substantially rigid, elastically deformable, and plastically deformable fasteners. The holes may be smooth or threaded, and the bosses or fasteners may threaded or unthreaded.

It will be understood that any desired combination of fasteners may be used, such that the attachment feature 42 cooperates with any of the attachment features 32 of the rail 30 such that the attachment members 36, 44, and 46 may be selectively attachable to any of the first attachment features 32 of the mounting rail 30. It will be further understood that, if desired, an adhesive may be used in the dovetail joint 34, or within any of the alternative attachment features described herein.

The motor attachment member 36, second attachment member 44, and third attachment member 46 illustrated and described herein may be fabricated or otherwise formed from a suitable substantially rigid material such as for example, steel, aluminum, alloys thereof, plastic, resin, or other metals and non-metals. Alternatively, the motor attachment member 36, second attachment member 44, and third attachment member 46, may be formed from a substantially flexible material, such that the members 36, 44, and 46 may be selectively shaped to define a plurality of external contours or shapes, and therefore be mounted to rails 30 used in any of a plurality of power seat drive assemblies or seat frames configurations. Suitable flexible materials include plastic and resin, such as for example, glass-filled nylon. Alternatively, other suitable materials, such as metal or other non-metals may be used.

The embodiments of the mounting rail assembly 10 described and illustrated herein have been described in the context of a mounting rail assembly for a drive motor coupled to operate a vehicle power seat drive assembly. Alternatively, the mounting rail assembly 10 may be used at any desired location within the vehicle, such as for example, coupled to operate a vehicle power window assembly (not shown) and/or a vehicle power door lock assembly (not shown).

The principle and mode of operation of the mounting rail assembly have been described in its various embodiments. However, it should be noted that the mounting rail assembly described herein may be practiced otherwise than as specifically illustrated and described without departing from its scope.

What is claimed is:

1. A mounting rail assembly for a drive motor coupled to operate a vehicle mechanism, the mounting rail assembly comprising:
a vehicle frame member;
a mounting rail secured to said vehicle frame member and having a plurality of spaced apart first attachment features; and
a drive motor having a second attachment feature and being selectively attachable to any of said first attachment features of said mounting rail to provide a desired motor mounting location relative to said vehicle frame member.

2. The mounting rail assembly according to claim 1, wherein said drive motor having said second attachment feature defines a first attachment member, said mounting rail assembly further including a second attachment member, said second attachment member having said second attachment feature and being selectively attachable to any of said first attachment features of said mounting rail to provide a desired motor mounting location relative to said vehicle frame member.

3. The mounting rail assembly according to claim 2, wherein said second attachment member is a mount for attaching said mounting rail to said vehicle frame member.

4. The mounting rail assembly according to claim 2, wherein said second attachment member is a mount for attaching a vehicle component to said mounting rail.

5. The mounting rail assembly according to claim 1, further including a drive motor attachment member having said second attachment feature, said drive motor attachment member being attachable to said drive motor and selectively attachable to any of said first attachment features of said mounting rail to provide a desired motor mounting location relative to said vehicle frame member.

6. The mounting rail assembly according to claim 5, wherein said drive motor attachment member defines a first attachment member, said mounting rail assembly further including a second attachment member, said second attachment member having said second attachment feature and being selectively attachable to any of said first attachment features of said mounting, rail to provide a desired motor mounting location relative to said vehicle frame member.

7. The mounting rail assembly according to claim 1, wherein said mounting rail is flexible such that said mounting rail may be secured to any of a plurality of vehicle frame members in a plurality of vehicles.

8. The mounting rail assembly according to claim 7, wherein said mounting rail is formed of glass-filled nylon.

9. The mounting rail assembly according to claim 1, wherein said first and second attachment features define cooperating portions of a dovetail joint.

10. The mounting rail assembly according to claim 1, wherein said mounting rail assembly is coupled to operate a vehicle power seat drive assembly.

11. The mounting rail assembly according to claim 1, wherein said mounting rail assembly is coupled to operate at least one of a vehicle power window assembly and a vehicle power door lock assembly.

12. A power seat drive assembly for a vehicle seat, said power seat drive assembly comprising:
a vehicle seat frame member;
a power seat drive motor;
a drive mechanism powered by said drive motor, said drive mechanism structured and configured for moving a portion of a vehicle seat from a first position to a second position;
a mounting rail secured to said vehicle seat frame member and having a plurality of spaced apart first attachment features; and
a drive motor having a second attachment feature and being selectively attachable to any of said first attachment features of said mounting rail to provide a desired motor mounting location relative to said vehicle seat frame member.

13. The power seat drive assembly according to claim 12, wherein said drive motor having said second attachment feature defines a first attachment member, said power seat drive assembly further including a second attachment member, said second attachment member having said second attachment feature and being selectively attachable to any of said first attachment features of said mounting rail to provide a desired motor mounting location relative to said vehicle frame member.

14. The power seat drive assembly according to claim 13, wherein said second attachment member is a mount for attaching said mounting rail to said vehicle frame member.

15. The power seat drive assembly according to claim 13, wherein said second attachment member is a mount for attaching a vehicle component to said mounting rail.

16. The power seat drive assembly according to claim 12, further including a drive motor attachment member having said second attachment feature, said drive motor attachment member being attachable to said drive motor and selectively attachable to any of said first attachment features of said mounting rail to provide a desired motor mounting location relative to said vehicle frame member.

17. The power seat drive assembly according to claim 16, wherein said drive motor attachment member defines a first attachment member, said mounting rail assembly further including a second attachment member, said second attachment member having said second attachment feature and being selectively attachable to any of said first attachment features of said mounting rail to provide a desired motor mounting location relative to said vehicle frame member.

18. The power seat drive assembly according to claim 12, wherein said mounting rail is flexible such that said mounting rail may be secured to any of a plurality of vehicle frame members in a plurality of vehicles.

19. The power seat drive assembly according to claim 12, wherein said first and second attachment features define cooperating portions of a dovetail joint.

20. A mounting rail assembly for a vehicle component, the mounting rail assembly comprising:
a vehicle frame member;
a mounting rail secured to said vehicle frame member and having a plurality of spaced apart first attachment features; and
a vehicle component having a second attachment feature and being selectively attachable to any of said first attachment features of said mounting rail to provide a desired motor mounting location relative to said vehicle frame member.
